(19) United States
(12) Patent Application Publication
(10) Pub. No.: US 2004/0179462 A1
(43) Pub. Date: Sep. 16, 2004

(54) Optical disc having increased storage capacity

(75) Inventors: Robert I. Freedman, Culver City, CA (US); Steven Rogers, Los Angeles, CA (US); Ruben Marquez, Canyon Country, CA (US)

Correspondence Address: BRIAN M BERLINER, ESQ, O'MELVENY & MYERS, LLP, 400 SOUTH HOPE STREET, LOS ANGELES, CA, 90071-2899, US

(73) Assignee: NATIONAL FILM LABORATORIES, INC. dba CREST NATIONAL

(21) Appl. No.: 10/385,242

(22) Filed: Mar. 10, 2003

(51) Int. Cl. G11B 7/24

(52) U.S. Cl. 369/275.4

(57) ABSTRACT

The invention pertains to an optical disc having increased storage capacity that provides sufficient signals for readability in a majority of players. Pursuant to a first aspect of the invention, acceptable cross-talk levels and increased storage capacity are achieved by decreasing track pitch and pit width. Pit width is decreased based in part on the amount the track pitch has been decreased, and in part on cross-talk levels that are produced by the optical disc when scanned in a majority of players. Pursuant to a second aspect of the invention, acceptable data signals, acceptable tracking signals, and increased storage capacity are achieved by decreasing the pit lengths and by selecting a pit depth. The pit depth is selected based in part on the pit lengths, and based in part on the data signals and the tracking signals produced by the optical disc when scanned in a majority of players. Pursuant to a third aspect of the invention, a cross sectional shape of the pits is selected so that the cross sectional shape increases tracking signals produced by the optical disc when the disc is read in a majority of players.

### BACKGROUND OF THE INVENTION

1. Field of the Invention

The present invention relates to optical discs, and more particularly, to optical discs that have an increased storage capacity and that are readable in a majority of players.

2. Description of Related Art

Optical discs have become the preferred media used for data storage purposes because of their many advantages. For example, optical discs can store greater amounts of information in a smaller space than other types of media, such as magnetic tape and paper. In addition, optical discs allow for accurate data retrieval without wear and tear to the disc or to the player used to retrieve the data on the disc. This allows optical discs to be used over and over again, unlike magnetic media, which incurs substantial wear and tear after repeated use. This substantially limits the life span of such magnetic media. Moreover, optical discs use digital technology which allows for the correction of errors incurred while retrieving data from the optical disc. If, for example, there is a scratch on the optical disc, encoding and decoding schemes used in digital technology allow the data to be retrieved accurately, despite the scratch. There are no such features in analogous media, such as cassette tapes for example.

In optical discs, data is stored on a spiral line that starts at the inside of the disc and extends to the outside of the disc. A single 360° revolution of the spiral line is called a track, and a series of pits and lands are formed on each track. Pits are indentations in the track, and lands are those portions of the track without an indentation. A player differentiates between pits and lands by projecting a light onto the track. The amount of light reflected back from a pit is differentiated against the amount of light reflected back from a land. The player uses this differentiation to produce a data signal. The data signal is then processed and translated into a series of binary “0”s and “1”s. These binary “0”s and “1”s are then processed and translated further to reproduce the data stored on the disc. The data includes, for example, audio or video data, photos, pictures, text, and/or software.

The specific layout, dimensions, and geometry of the tracks, pits, and lands determine whether a player can properly read the data stored on the discs. To allow for optical discs to be read in a majority of players, in 1982, Sony and Phillips released suggested specifications for optical discs in a reference called the Red Book. In order to prepare the specification, many factors had to be taken into account. For example, the specifications had to allow for the interoperability of the optical discs in different players. Thus, the Red Book had to suggest specifications that would allow players having different capabilities, requirements, and margins to read optical discs that-were manufactured pursuant to the Red Book specifications. Further, the Red Book had to take into account the technology limitations of players and the technology limitations of optical disc manufacturing available at the time. Based on these factors, the Red Book published several suggested specifications for optical discs. For example, the Red Book suggests the following specifications for optical discs: (1) a specific track pitch, which is the distance between adjacent tracks, and (2) a constant linear velocity at which the discs should be scanned in players. A majority of players were manufactured to be able to read discs having the specifications suggested by the Red Book. Thus, discs having the specifications suggested in the Red Book will produce sufficient signals when the disc is scanned by a majority of players that will permit the players to properly read the data on the discs.

Examples of the signals that must be produced by the disc when being scanned by the player are: (1) cross-talk, which is a measure of interference caused by the impingement or proximity of a laser spot that is projected by the player on adjacent tracks when the player is attempting to read a particular track, (2) data signals, which are a measure of the actual signal produced by the disc when the player attempts to read the disc, and (3) tracking signals, which are out of phase with the data signal by one-quarter of a wavelength and which signal the player uses to keep the projected light on the track that is attempted to be read (as opposed to an adjacent track).

Most optical discs have a diameter of 120 mm, and miniature optical discs have a diameter of less than 120 mm. Most miniature optical discs have a diameter of about 80 mm. In general, both 120 mm optical discs and miniature optical discs are manufactured pursuant to Red Book specifications because a majority of players can only read those optical discs that comply with Red Book specifications. Although optical discs manufactured per the specifications suggested by the Red Book produce sufficient signals for readability in a majority of players, such optical discs have limited storage capacities. When optical discs are manufactured pursuant to the Red Book specifications, 80 mm diameter optical discs can only hold about 200 Mbytes of data, and 120 mm diameter optical discs can only hold about 700 Mbytes of data. Many optical disc applications require that the 80 mm and 120 mm discs hold more than the 200 Mbytes and 700 Mbytes of data, respectively.

Traditionally, there was not a need to improve the storage capacity of miniature optical discs because when there was a need for increased storage capacity, an optical disc having a diameter of 120 mm was used. Nonetheless, because miniature optical discs have become increasingly popular for marketing and promotional purposes, a need for miniature optical discs having increased storage capacity has developed. Specifically, miniature optical discs are often distributed as part of marketing campaigns to reduce packaging and distribution costs. But, because of the data restrictions of miniature optical discs, the amount of marketing material that can be stored on the miniature discs is limited. Thus, it is desirable to increase the storage capacity of miniature optical discs in order to use the miniature optical discs effectively in marketing campaigns.

Optical discs having a diameter of 120 mm are often used to store image data, audio data, video data, and other types of data. Many entities utilize optical discs to store images of documents to meet their document archival needs. Other entities, such as record companies, sell audio optical discs that have sound recordings stored on the discs. These entities may wish to store even more image data or longer sound recordings on optical discs, but cannot do so without exceeding the 700 Mbytes limit imposed by Red Book compliance.

Thus, the Red Book succeeded in providing specifications that allowed optical discs to be read in a majority of players, but did not succeed in allowing for optical discs to meet the increased storage capacity demands of today. Previous attempts have been made to increase the storage capacity of 120 mm diameter optical discs, but those attempts resulted in optical discs that did not produce sufficient signals for readability when scanned in a majority of players. Specifically, the attempts resulted in optical discs that did not comply with Red Book specifications. And, because a majority of players were designed to read Red Book complaint discs, the players could not read the non-compliant discs.

For example, one known method of increasing the capacity of optical discs was to decrease the track pitch from the track pitch suggested by the Red Book. A drawback of this method is that it is susceptible to producing high cross-talk levels, rendering the optical disc unreadable in a majority of players. As discussed above, cross-talk is a measure of the amount of interference that an adjacent track causes when the player is attempting to read a particular track. The interference is typically caused when a laser spot projected by the player impinges on or is in close proximity to the adjacent track. The interference is often too high for readability when the track pitch is decreased beyond the specification suggested by the Red Book. Another known method for increasing storage capacity was to decrease the constant linear velocity at which the players scanned discs from the constant linear velocity suggested by the Red Book. Decreasing the constant linear velocity was typically accomplished by decreasing the lengths of the pits and lands. Each pit and land is configured to store a predetermined amount of data, and if the lengths of the pits and lands are decreased, the disc can hold more pits and lands, and thus more data. But decreasing the constant linear velocity (by decreasing the pit and land lengths) weakens the data signal produced by the optical disc when scanned by a majority of players, rendering the optical disc unreadable by a majority of players.

In sum, although the known methods described above, and variations thereof, increased the storage capacity of the optical disc, such methods caused the optical discs to produce inadequate signals when scanned in a majority of players, rendering the optical discs unreadable by the players. Rather, optical discs manufactured by the described known methods were only readable in newer types of equipment, making such optical discs unusable by a majority of the population that already owns players that were designed to read optical discs manufactured per Red Book specifications. As a result, these methods were especially ineffective to produce miniature optical discs that are to be distributed for promotional or marketing purposes.

Thus, there still remains a need for optical discs that have an increased storage capacity and that are readable in a majority of players.

### SUMMARY OF THE INVENTION

The present invention addresses the need for an optical disc with increased storage capacity that is readable in a majority of players.

Pursuant to a first aspect of the invention, acceptable cross-talk levels and increased storage capacity are achieved by decreasing track pitch and pit width. In an embodiment of the first aspect of the invention, optical discs are manufactured by spacing adjacent tracks of the disc a predetermined distance from one another. The predetermined distance is shortened when the desired storage capacity of the optical disc is increased. Each track includes a series of pits and lands, and the width of the pits are selected based in part on the predetermined distance between adjacent tracks. The width of the pits are decreased when the predetermined distance is decreased. Selecting the pit widths, based in part on the predetermined distance between adjacent tracks, allows the disc to produce sufficient cross-talk levels for readability when scanned in a majority of players.

In other embodiments of the first aspect of the invention, the optical disc having the spaced adjacent tracks is measured for cross-talk levels, and the width of the pits is reselected based in part on the measured cross-talk levels.

Another embodiment of the first aspect of the invention includes an optical disc that includes a substrate. The substrate has a plurality of spiral tracks formed on the substrate, and each track includes a series of pits and lands. A predetermined distance between each adjacent track is less than about 1.5 microns. The predetermined distance between each adjacent track is based in part on the desired storage capacity of the optical disc. The widths of each pit is based in part on the predetermined distance between adjacent tracks. A reflective layer is in direct contact with the tracks of the substrate. Such optical discs of the invention have an increased storage capacity because of the decreased predetermined distance between tracks, and are readable by a majority of players because the pit widths are based in part on the predetermined distance between tracks.

Pursuant to a second aspect of the invention, acceptable data signals, acceptable tracking signals, and increased storage capacity are achieved by decreasing the pit lengths and by selecting the pit depth. In an embodiment of a second aspect of the invention, optical discs are manufactured by forming pits. The lengths of the pits are shortened when the desired storage capacity of the optical disc is increased. Each pit also has a depth, and the pit depths are selected based in part on the pit lengths. Decreasing the pit lengths increases the storage capacity of the optical discs, and selecting the pit depths based in part on the pit lengths allows the optical disc to produce sufficient data signals and tracking signals for readability when scanned in a majority of players.

In other embodiments, the optical disc is measured for data signals and tracking signals, and the pit depths are reselected based in part on the data signals and the tracking signals.

Another embodiment of the second aspect of the invention includes optical discs that have a substrate that includes a plurality of spiral tracks formed on the substrate. Each track includes a series of pits and lands, and each pit has one of nine possible discrete pit lengths and a pit depth. The pit lengths are based in part on the desired storage capacity, and the pit depths are based in part on the nine possible pit lengths. A reflective layer is in direct contact with the tracks of the substrate. Such optical discs of the invention have an increased storage capacity because of the pit lengths, and are also readable by a majority of players because of the pit depths.

Pursuant to a third aspect of the invention, a cross sectional shape of the pits is selected to increase tracking signals produced by the optical disc when scanned in a majority of players. In an embodiment of a third aspect of the invention, a substantially semi-hexagonal shape is selected.

A more complete understanding of the optical disc with increased capacity will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1a is a top view of an optical disc having a diameter of about 120 mm;

FIG. 1b is a top view of an optical disc having a diameter of about 80 mm;

FIG. 2 is an enlarged view of an optical disc showing three tracks having a series of pits and lands;

FIG. 3 is a cross sectional view of the optical disc of FIG. 1a showing a substrate and a reflective layer;

FIG. 4a is an enlarged view of an optical disc showing three tracks having a series of pits and lands, and a laser spot emitted from a player (not shown);

FIG. 4b is an enlarged view of an optical disc of the invention showing three tracks having a series of pits and lands, and a laser spot emitted from a player (not shown);

FIG. 5a is a cross sectional view of an I11 pit of FIG. 2, along the length of the pit;

FIG. 5b is a cross sectional view of an I3 pit of FIG. 2, along the length of the pit;

FIG. 6a is an enlarged top view of a pit with a laser spot emitted onto the pit by a player (not shown);

FIG. 6b is an enlarged top view of a pit, that is shorter in length than the pit of FIG. 6a, with a laser spot emitted onto the pit by a player (not shown);

FIG. 7 is a graph of data signals, and their respective amplitudes, produced by pits having different lengths when an optical disc is scanned in a player;

FIG. 8 is a graph of a tracking signal and a data signal produced by an optical disc when the optical disc is spun by a player at different constant linear velocities; and,

FIG. 9 is a cross sectional view of a pit, along a width of the pit.

### DETAILED DESCRIPTION OF THE PREFERRED EMBODIMENT

The present invention satisfies the need for an optical disc having increased storage capacity that can be read in a majority of players. Specifically, pursuant to the invention, the optical disc produces acceptable cross-talk levels, sufficient data signals and sufficient tracking signals to permit readability in a majority of players. Pursuant to a first aspect of the invention, acceptable cross-talk levels and increased storage capacity are achieved by decreasing track pitch and pit width. Pit width is decreased based in part on the amount the track pitch has been decreased, and in part on cross-talk levels that are produced by the optical disc when scanned in a majority of players. Pursuant to a second aspect of the invention, acceptable data signals, acceptable tracking signals, and increased storage capacity are achieved by decreasing the pit lengths and by selecting a pit depth. The pit depth is selected based in part on the pit lengths, and based in part on the data signals and the tracking signals produced by the optical disc when scanned in a majority of players. Pursuant to a third aspect of the invention, a cross sectional shape of the pits is selected to increase tracking signals produced by the optical disc when read in a majority of players.

A description of a method in which data can be stored in optical discs and in which the data on the optical disc can be read by players is provided below.

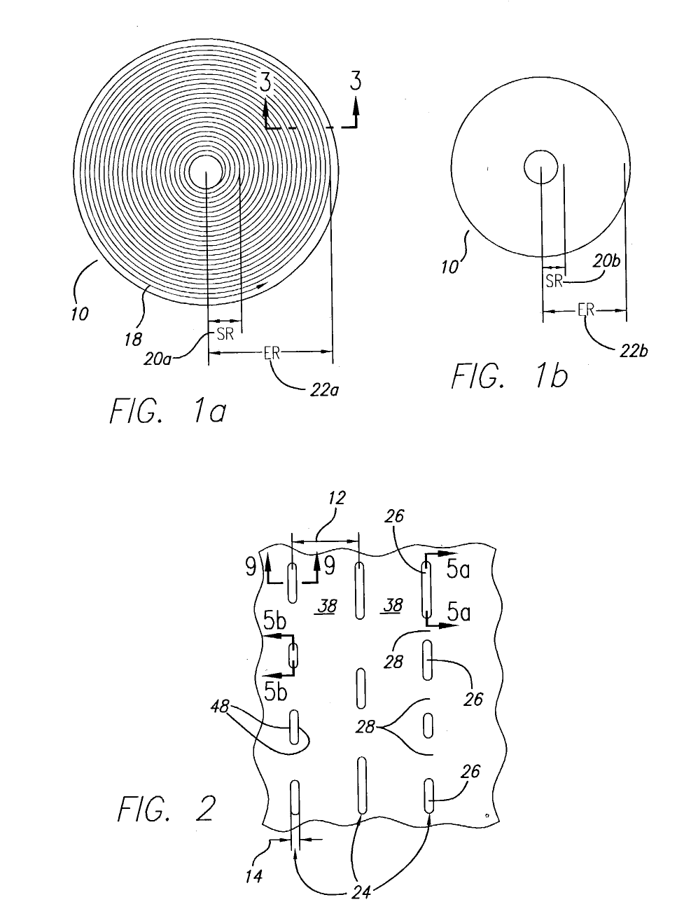

Referring now to FIGS. 1a-1b, data is stored on optical discs 10 in a continuous spiral line 18. For optical discs 10 having a diameter of 120 mm (FIG. 1a), the Red Book suggests that an inner radial position (Start Radius (SR) 20a) at which substantive data is stored should be about 25 mm, and an outer radial position (End Radius (ER) 22a) at which substantive data is stored should be about 58 mm. For optical discs 10 having a diameter of 80 mm (FIG. 1b), the inner radial position 20b at which substantive data is stored is typically 25 mm, and the outer radial position 22b at which substantive data is stored is typically 38 mm. Note that for purposes of this disclosure, substantive data refers to the type of data that was intended for user access. For example, for audio optical discs, substantive data encompasses audio data, and for other optical discs, substantive data can encompass pictures, text, video and/or audio data.

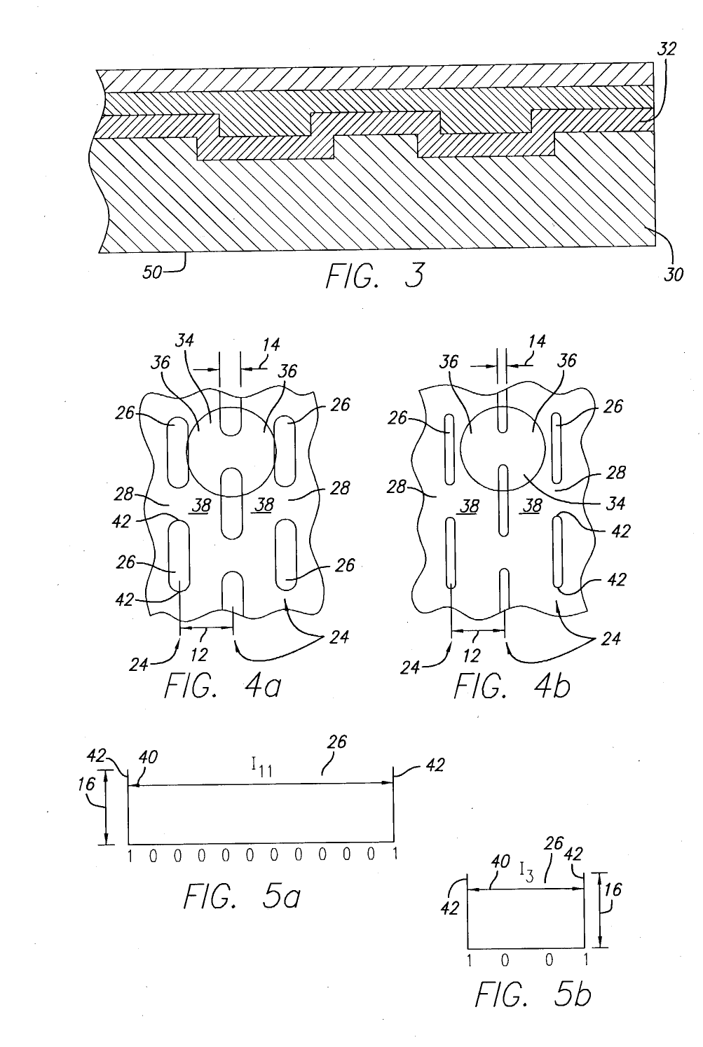

A single 360° rotation of the line of data around the disc is called a track 24. FIG. 2 shows a portion of an optical disc 10 with portions of three adjacent tracks 24. Each track 24 includes a series of pits 26 and lands 28, which are formed in a substrate 30 of the disc 10, shown in FIG. 3. The pits 26 are indentations in the spiral track 24, and lands 28 are portions of the track 24 that do not have indentations. In one embodiment, the substrate 30 is typically about 1.2 mm in thickness and typically has a refractive index of about 1.55. A reflective layer 32, usually comprised of aluminum, gold, or silver, for example, is formed on the substrate 30 where the pits 26 and lands 28 are formed. Note that the scope and spirit of this invention includes optical discs 10 comprised of substrates 30 having different refractive indexes and thickness, and having reflective layers 32 comprised of different materials.

Data in optical discs 10 is stored as pits 26 and lands 28, where each pit and land typically has a discrete length. Most optical discs use Eight to Fourteen Modulation (EFM) coding (described below) and have nine discrete pit lengths, which are usually identified by I3, I4, I5, I6, I7, I8, I9, I10, and I11. As shown in FIGS. 5a-5b, the length 40 of a pit 26 or land 28 signifies a plurality of binary “0” values, and the edge 42 of a pit 26 signifies a binary “1” value. For example, the digital pattern for the longest pit 26, an I1 pit, would be 100000000001. The first “1” corresponds to the first edge 42 of the pit 26, the ten “0”s are based on the length 40 of the pit 26, and the last “1” corresponds to the second edge 42 of the pit 26. The digital pattern of the shortest pit 26, which is an I3 pit, would be 1001. The first “1” is the first edge 42 of the pit 26, the two “0”s are based on the length 40 of the pit 26, and the last “1” is the second edge 42 of the pit 26. To require a minimum and maximum number of consecutive binary “0” values, and thus, to control the number of pits and the proximity of pits along a track, as the pit edges 42 correspond to “1”s, optical discs use EFM. EFM is a type of data coding standard that translates 8 bits of data into 14 bits of data. Note that other optical discs may use different coding mechanisms, such as, for example 4/9 modulation, which converts 4 bits of data into 9 bits of data.

To allow for proper data reading, the pits 26 and lands 28 must have lengths that are proportional and consistent with one another, throughout the entire optical disc 10. The lengths of the pits 26 and lands 28 may vary in different optical discs 10, but within the same optical disc, the pit and land lengths must be proportional to one another. Those optical discs 10 having shorter lands 28 and pits 26 carry larger amounts of data. For example, an optical disc 10 having a shorter I11 pit or land can convey the “100000000001” data in a shorter distance than an optical disc having a longer I11 pit or land. And, as described above, because the pits 26 and lands 28 must be proportional throughout the optical disc, all lands and pits (including the I3 to the I10 pits and lands) of the optical disc having a shorter I11 pit or land are shorter than corresponding lands and pits of optical discs having a longer I11 pit or land.

There is an equal amount of data on an optical disc 10 along uniform distances along a track 24. To increase the maximum amount of data that can be read from an optical disc 10, players spin the optical disc at a constant linear velocity (CLV), not at a constant angular velocity. Thus, an optical head of a player (not shown) scans the same distance of track, which is the same amount of data on a track, in a predetermined amount of time, irrespective of the radial position of the optical head. Most players scan data at a predetermined rate. For example, as suggested in the Red Book, most players scan data at a rate of about 4.32 Mbits/second.

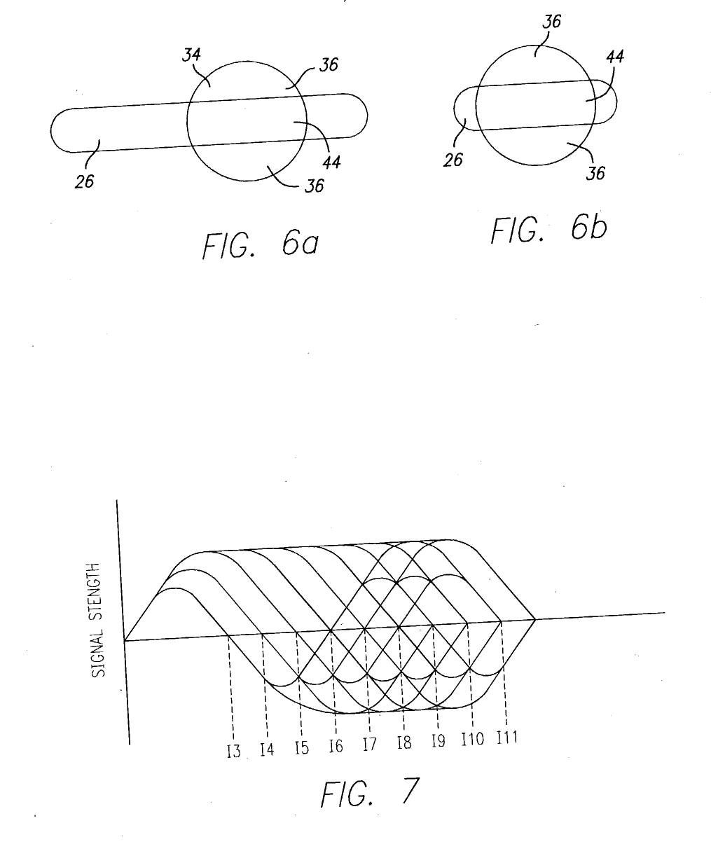

Players use destructive interference to read the data stored in the pits 26 and lands 28. Specifically, players project a laser light onto the track, and as described above, the laser is focused down to a spot 34 when it contacts the track 24. A center portion 44 of the laser spot 34 (FIGS. 6a-6b) falls within the pit 26 and the peripheral portions 36 of the spot 34 fall on an optical disc portion 38 adjacent to the pit 26, as shown in FIGS. 4a-4b. The laser then contacts the reflective layer 32, and is reflected back to the optical head of the player. The data signal and the tracking signal are comprised of the reflected light. Optical sensors in the player detect the strength of the reflected signal. Specifically, the optical sensors detect when there are transitions from land 28 to pit 26 and from pit 26 to land 28, which transitions are pit edges 42 that reflect binary “1” values. The sensors detect the transitions by measuring the amount of light in the reflected signal in the pits 26 and in the lands 28.

The depth 16 of the pit 26 determines the amount of destructive interference. For example, maximum destructive interference, and thus maximum signal strength, occurs when the pit depth 16 is one-quarter of a wavelength. Per the Red Book, a majority of players include a lens having a numerical aperture (NA) of 0.45 and emit a light having a wavelength of about 780 nm. The wavelength of the light is reduced to about 500 nm when traveling through a substrate 30 having a refractive index of 1.55. Thus, for maximum destructive interference, when functioning with a majority of players, the pit depth 16 is about 125 nm.

When the center portion 44 of the laser spot 34 hits the bottom of the pit 26 having a depth 16 of about one-quarter of a wavelength, it is out of phase with peripheral portions 36 of the spot 34 by about one-half of a wavelength when the light is reflected back to the player head. At this point, there is maximum destructive interference. The optical sensors differentiate between pits 26, lands 28, and transitions between the two by differentiating the amount of light reflected when the laser hits a pit against the amount of light when the laser hits a land. The difference in the amount of light reflected is greatest when there is maximum destructive interference, and thus, the signal is the strongest when there is maximum destructive interference. Because the pit depth 16 affects the amount of destructive interference, it also affects the strength of the data signal.

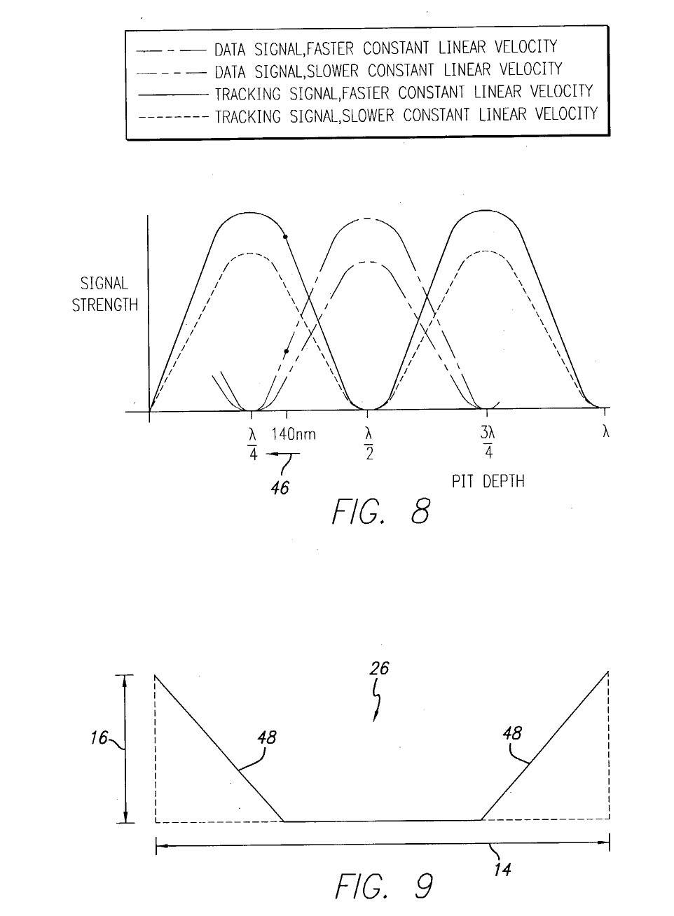

When reading a disc, the laser spot 34 must also stay centered on one spiral track 24, and players usually accomplish this by the use of a tracking signal. Many players incorporate a push/pull tracking system in which the data signal and the tracking signal are out of phase by about one-quarter of a wavelength. Thus, as shown in FIG. 8, the tracking signal has a maximum value when the data signal has a minimum value. Because such players require at least a minimum tracking signal to properly read a disc, a pit depth of about 140 nm is usually selected, which is slightly greater than one-quarter of a wavelength (of 780 nm light within a material having a refractive index of 1.55). The 140 nm pit depth of most optical discs provides acceptable data signal strength while also providing acceptable tracking signal strength.

Note that several players also use a three-beam tracking mechanism in which the tracking signal is not out of phase with the data signal by one-quarter of a wavelength. Players using three-beam tracking systems can also read optical discs having a pit depth 16 that is selected to produce a sufficient tracking signal in players incorporating push/pull tracking. As a result, in order to permit readability in both players that incorporate push/pull tracking systems, and in players that incorporate three-beam tracking systems, optical discs are manufactured having depths of about 140 nm.

Prior attempts to increase storage capacity included decreasing track pitch 12 and decreasing the constant linear velocity at which the optical disc is scanned in players. Both of these attempts, however, resulted in other undesirable effects. Both the prior attempts to increase capacity and the resulting undesirable effects are described below.

Track pitch 12 is the distance between adjacent tracks 24 of data on an optical disc 10, as shown in FIG. 2. By decreasing track pitch 12, it should be appreciated that more tracks 24 can be fitted onto an optical disc 10, and thus more data can be stored on the optical disc. But, as shown in FIG. 4a, reducing the track pitch 12, especially below the distance suggested in the Red Book, often leads to unacceptable cross-talk levels (explained below) when the optical disc is scanned in most players, rendering the optical disc unreadable in a majority of players.

In particular, a majority of players include a lens having a numerical aperture of about 0.45 and emit a laser having a wavelength of about 780 nm that produces a laser spot 34 of about 800 microns in diameter when it contacts a first side 50 of the substrate 30 of the optical disc 10. (The first side 50 of the substrate 30 is the side opposite the label, the shiny side of an optical disc.) The diameter of the laser spot 34 is typically reduced to about 1.7 microns when it is refracted through the substrate 30. Per the specifications of the Red Book, the recommended track pitch ranges from about 1.5 to about 1.7 microns. This is because reducing the track pitch, as shown in FIG. 4a, causes peripheral portions 36 of the laser spot 34 to be unacceptably near or impinge upon pits 26 and/or lands 28 of adjacent tracks 24. This impingement and/or proximity to adjacent tracks 24 causes the adjacent tracks 24 to interfere with the signal produced by the track 24 on which the laser spot 34 is focused. Cross-talk is a measure of the interference caused by the impingement or proximity of the laser spot 34 to adjacent tracks 24, and unacceptable cross-talk levels distort the data signal produced by the optical disc 10.

Thus, decreasing the track pitch often leads to unacceptable cross-talk levels, rendering such optical discs having a decreased track pitch unreadable in a majority of players. In particular, those optical discs in which the track pitch was reduced are typically only readable in players that include a lens having a different aperture and/or a laser of a smaller wavelength that produces a laser spot having a diameter of less than 800 microns when the laser spot contacts the first side 50 of the substrate 30.

Decreasing the constant linear velocity at which players scan optical discs increases storage capacity but also causes other undesirable affects, which are described below. As described above, optical discs can hold greater amounts of data by shortening the lengths of the pits 26 and lands 28. Because players scan optical discs at a specified data rate, usually 4.32 Mbits/sec, the greater the amount of data in a given distance, the lower the constant linear velocity. Thus, players spin optical discs 10 having shorter lands 26 and pits 28 at a lower constant linear velocity to maintain the predetermined scan rate.

The Red Book suggests that optical discs be scanned at a constant linear velocity of about 1.2 m/s to about 1.4 m/s. To be scanned at 1.2 m/s, optical discs should have pit lengths ranging from about 0.83 microns (for an I3 pit) to about 3.05 microns (for an I11 pit), and to be scanned at 1.4 m/s, optical discs should have pit lengths ranging from about 0.97 microns (for an I3 pit) to about 3.56 microns (for an 111 pit). The I3 pit includes 3 bits of data and an I1 pit includes 11 bits of data, and thus the distance per data unit at a scanning velocity of 1.2 m/s is about 0.28 microns, and the distance per data unit at a scanning velocity of 1.4 m/s is about 0.32 microns.

But, lowering the constant linear velocity decreases the strength of the data signal, especially when lowered beyond those velocities suggested by the Red Book. The strength of the data signal is weakened when the pit 26 and land 28 lengths are shortened because destructive interference can be achieved only when the laser spot 34 is within the pit 26, as shown in FIG. 6a. Pits 36 and lands 28 having shorter distances typically produce weaker data signals because the laser spot is in the pits 26 and lands 28 for a shorter amount of time, as shown in FIGS. 6b and 7. (FIG. 7 shows the signal strength of pits 26 of different lengths. For example, the I3 signal has a lower amplitude, because of its shorter length, than the I7 signal, which has a longer length.) As a result, when the constant linear velocity is reduced by decreasing the pit 26 and land 28 lengths, the data signal is weakened.

Such optical discs with decreased pit 26 and land 28 lengths are therefore unreadable in a majority of players. In particular, those optical discs are typically only readable in players that include a lens having a different aperture and a laser of a smaller wavelength that produce a laser spot having a diameter of less than 800 microns when it contacts the first side 50 of the substrate 30.

In sum, the storage capacity of an optical disc can be increased by decreasing track pitch 12 and by decreasing the constant linear velocity at which the disc is scanned in the player. But such optical discs produce unacceptable cross-talk levels and weakened data and tracking signals when scanned in a majority of players, rendering the optical discs unreadable in a majority of players. Aspects of the invention address the undesirable effects of unacceptable cross-talk levels and weakened data and tracking signals resulting from decreasing track pitch and decreasing the constant linear velocity at which the optical discs are scanned in players. This allows optical discs 10 of the invention to have an increased storage capacity while still being readable in a majority of players.

Pursuant to a first aspect of the invention, because decreasing track pitch 12 to achieve greater storage capacity also causes unacceptable cross-talk levels, a width 14 of each pit 26 is selected to allow for acceptable cross-talk levels. Specifically, the pit width 14 is selected based in part on the track pitch 12 and based in part on cross-talk levels produced by the optical disc 10 (having a decreased track pitch) when scanned in a player. As shown in FIG. 4b, by narrowing the pit width 14, the laser spot 34 is in contact with the target track 24 and the adjacent optical disc portion 38, but is sufficiently spaced from pits 26 and lands 28 of adjacent tracks 24. In one embodiment, the pit width 14 of each pit 26 is the same.

In an embodiment of the invention, an optical disc 10 having a track pitch 12 in a range from about 1.1 microns to about 1.7 microns provides acceptable cross-talk levels after varying pit width 14. In the embodiment, the optical disc 10 has a substrate 30 of about 1.2 mm in thickness and a refractive index of about 1.55. The optical disc 10 provides acceptable cross-talk levels in players that include a laser having a wavelength of about 780 nm, and that include a one-beam push-pull type of tracking mechanism. The diameter of the laser spot 34 is about 800 microns when it contacts the first side 50 of the substrate 30, and is about 1.7 microns when it contacts the reflective layer 32. The optical disc 10 is therefore readable by a majority of players because a majority of players include a 780 nm laser and a lens having a NA of 0.45 that produces a 800 micron diameter laser spot 34 when it contacts the first side 50 of the substrate 30 of the optical disc 10. Further, in general, the embodiment of the optical disc will also produce adequate signals in players having lasers of different wavelengths, in players that produce a laser spot of about 800 microns or less when the spot contacts the first side of the substrate, in players that produce a laser spot of about 1.7 microns or less when the spot contacts the reflective layer, and in players that use three-beam tracking mechanisms.

In another embodiment, the width 14 of the pits 26 is selected based in part on the track pitch 14. The track pitch 14 is decreased if a desired storage capacity of the optical disc 10 is increased. If it appears that the optical disc 10 will produce adequate cross-talk levels for readability at the decreased track pitch 12 and the current pit widths 14, the current pit widths are selected. On the other hand, if it appears that the optical disc 10 will produce unacceptable cross-talk levels at the decreased track pitch 12, the pit width 14 is selected by decreasing the width. In another embodiment, the cross-talk levels produced by the optical disc 10 are measured, and the pit width 14 can be reselected based in part on the measured cross-talk levels. If the cross-talk levels are acceptable, the pit widths 14 are reselected by not changing the dimensions of the widths. In sum, the track pitch 12 is decreased to provide an increased storage capacity, and the pit width 14 is selected to provide cross-talk levels that allow the optical disc to be read in a majority of players.

Pursuant to a second aspect of the invention, because decreasing constant linear velocity (which also decreases pit and land lengths) to achieve greater storage capacity also reduces data signal strength, the pit depth 16 is selected to allow for a stronger data signal while still maintaining a sufficient tracking signal. As a result, the pit depth 16 is selected based in part on the constant linear velocity, and thus, based in part on the pit 26 and land 28 lengths. The pit depth 16 is also based in part on the data signal and the tracking signal produced by the optical disc when scanned in a player. In one embodiment, the depth 16 is selected so that the depth 16 is closer to about one-quarter of a wavelength, as shown by the arrow 46 in FIG. 8. In one embodiment, the pit depth 16 of each pit 26 is the same.

In another embodiment, an optical disc 10 having a selected pit depth 16 that is scanned at constant linear velocities in a range of about 0.7 m/s to about 1.4 m/s provides acceptable data signals and tracking signals. In a player that has a scan rate of about 4.32 Mbits/second, at 0.9 m/s, an I3 pit length is about 0.625 microns and an I11 pit length is about 2.292 microns. The lengths of other pits at various scan rates and constant linear velocities can be determined based on the following equation, which is identified as Equation 1:

CLV(m/s)=Scan Rate(Mbits/sec)*[Pit Length(m)/N bits] Equation 1

wherein N is an integer that represents the number of data bits that a pit is to hold. For example, N would be 11 bits for an I11 pit.

In another embodiment, the optical disc 10 has a substrate 30 of about 1.2 mm in thickness and a refractive index of about 1.55. The optical disc 10 provides acceptable tracking signals and data signals in players that include a laser having a wavelength of about 780 nm and a lens having a NA of 0.45. The players produce a laser spot 34 having a diameter of about 800 microns when it contacts a first side 50 of a substrate 30, and a laser spot of about 1.7 microns when it contacts the reflective layer. These players include a one-beam push-pull type of tracking mechanism. The optical disc 10 is therefore readable by a majority of players because a majority of players include a 780 nm laser and a lens having a NA of 0.45 that produces a 800 micron diameter laser spot 34 when it contacts the first side 50 of the substrate 30 of the optical disc 10. Further, in general, the embodiment of the optical disc will also produce adequate signals in players having lasers of different wavelengths, in players that produce a laser spot of about 800 microns or less when the spot contacts the first side of the substrate, in players that produce a laser spot of about 1.7 microns or less when the spot contacts the reflective layer, and in players that use three-beam tracking mechanisms.

In one embodiment, the depth 16 of the pits 26 is selected based in part on the length 40 of the pits 26. The length 40 of the pits 26 is decreased if a desired storage capacity of the optical disc 10 is increased. If it appears that the optical disc 10 will produce adequate data signals and tracking signals for readability at the decreased pit lengths 40 and the current pit depth 16, the current pit depths are selected. If on the other hand, it appears that the optical disc 10 will produce unacceptable data signals and tracking signals at the decreased pit lengths 40, the pit depths 16 are selected by making the depth 16 closer to about one-quarter of a wavelength, which is about 125 nm for players including a lens having a NA of 0.45 and a 780 nm laser light moving through a 1.2 mm optical disc substrate that has a refractive index of about 1.55. In another embodiment, the data signals and tracking signals produced by the optical disc 10 are measured, and the pit depth 16 can be reselected based in part on the measured data signals and tracking signals. If the data signals and the tracking signals are acceptable, the pit depths are reselected by not changing the dimensions of the depths.

Pursuant to a third aspect of the invention, the cross sectional shape of the pit is selected to achieve stronger tracking signals. For example, as shown by the dotted line of FIG. 9, pits typically have a rectangular cross sectional shape. Pursuant to one embodiment of the third aspect, the sides 48 of the pit 26 are tapered inwardly so the cross-sectional shape of the pit resembles a semi-hexagonal shape. This allows for additional destructive interference along the sides 48 of the pit 26.

In sum, pursuant to aspects of the invention, one or more of the following may be performed to increase storage capacity and/or to decrease cross-talk levels and to increase the data and tracking signal strength: (1) providing a decreased track pitch 12 to increase data storage, and selecting a pit width 14 based in part on the decreased track pitch and based in part on the cross-talk levels produced; (2) decreasing constant linear velocity (or pit 26 and land 28 lengths) to increase data storage, and selecting a pit depth 16 based in part on the decreased pit 26 and/or land 28 lengths and based in part on the data signals and the tracking signals produced; and, (3) selecting the cross-sectional shape of the pit 26 to provide stronger tracking signals.

Note that there are several known optical disc manufacturing techniques. For example, several manufacturing techniques that may be used to manufacture an optical disc include, but are not limited to: (1) standard stamper injection molding; (2) direct read and write mastering; (3) direct metal mastering; (4) photopolymerization; and, (5) photolithography. These techniques may be used to practice the inventive aspects of providing a decreased track pitch, selecting pit widths, decreasing linear velocity (by decreasing pit and land lengths), selecting pit depths, and selecting the cross-sectional shape of a pit. An application of the known manufacturing techniques to practice the inventive aspects of the invention are within the spirit and scope of this invention.

For example, in the instance of the standard stamper injection molding manufacturing method, those skilled in the art will appreciate that one may use known methods to create a stamper that can mold an optical disc having a track pitch based in part on a desired storage capacity of the optical disc, and that can mold pits having pit lengths based in part on the desired storage capacity. Further, the stamper may also be adjusted to provide the selected pit widths and pit depths of the optical disc that are based in part on the track pitch and pit lengths, respectively. This can be done by adjusting the dimensions of the stamper. One may also adjust the dimensions of the stamper to provide the selected cross sectional shape of the pits.

In an embodiment of the invention, the track pitch 12 and pit widths 14 of an 80 mm disc are first decreased to increase storage capacity. The amount the track pitch 12 is decreased depends on the amount of desired storage capacity; the greater the desired storage capacity, the more the track pitch is decreased. The pit width 14 is then selected based in part on the track pitch 12. The cross-talk levels produced by the optical disc are measured with the decreased track pitch 12 and the selected pit width 14. The pit width 14 may then be reselected based in part on the cross-talk levels produced.

If the desired storage capacity cannot be achieved while maintaining acceptable cross-talk levels by decreasing the track pitch 12 and selecting the pit widths 14, the constant linear velocity is decreased. The pit depths 16 are then selected based in part on the decreased constant linear velocity, and thus based in part on decreased pit and land lengths. The optical disc, with the decreased pit 26 and land 28 lengths and the selected pit depth 16, is measured for data signals and tracking signals. The pit depths 16 are then reselected based in part on the data signals and the tracking signals produced.

One equation that can be used while determining track pitch and linear velocity values based on the desired storage capacity is shown below, and is identified as Equation 2:

Storage Capacity(sec)={[(ER(mm))²−(SR(mm))²]*π]}/{TP(mm)*CLV(mm/s)} Equation 2

The desired storage capacity value is given in seconds, and can be converted to the number of bytes desired by multiplying the value by a conversion factor that depends on the type of encoding scheme used for the substantive data. For example, a conversion factor based on common data encoding schemes for audio data is 0.147 Mbytes/second.

In Equation 2, ER signifies End Radius 22a, 22b, shown in FIGS. 1a and 1b, at which radius no further data may be stored on the optical disc, and SR signifies Start Radius 24a, 24b, at which radius data, and more specifically, substantive data, may start to be stored on the disc. TP signifies track pitch 12, and CLV signifies constant linear velocity. As described above, the track pitch 12 and constant linear velocity (and thus pit lengths 40) are based in part on the desired storage capacity. Other pit geometry variables, such as pit width 14 and pit depth 16, are then selected accordingly based in part on the track pitch and the constant linear velocity, respectively. The cross-talk levels, data signals, and tracking signals produced by the optical disc 10 may then be measured, and the pit widths 14 and the pit depths 16 may be reselected to achieve satisfactory cross-talk levels, data signals, and tracking signals. If acceptable tracking signals still cannot be achieved, the cross sectional shape of the pit 26 can be modified to increase the tracking signals.

In one embodiment, a storage capacity of 300 Mbytes can be produced in an optical disc 10 having a diameter of about 80 mm. The track pitch 12 is reduced to about 1.3 microns and the pit width 14 is reduced to about 0.324 microns. The pit width selection provides acceptable cross-talk levels. In this embodiment, the constant linear velocity at which the optical disc is to be spun is then reduced to about 1.0 m/s, which translates to an 111 pit length of about 2.55 microns when read on a player having a scan rate of 4.32 Mbits/sec. The pit depth 16 is selected at about 0.134 microns, which is about 0.266 of a wavelength of 780 nm light when traveling through a substrate that is 1.2 mm thick and that has a refractive index of 1.55. The pit depth selection provides a data signal of about 0.684 for I11 pits, and a data signal of about 0.314 for 13 pits. The pit depth selection allows for the optical disc to produce a tracking signal of the push/pull types of about 0.032, and the pit width selection allows for the optical disc to produce cross-talk levels of about 0.49. Note that these pit dimensions correspond to discs that are manufactured using standard stamper injection molding. The pit dimensions are measured a short time after the discs are exposed to the environment, when the discs absorb moisture from the environment. Specifically, the pit depth and pit width dimensions are about 20 to 25 nanometers greater after being exposed to the environment. The storage capacity is increased to about the desired 300 Mbytes.

Optical discs of the invention can hold a variety of data, including, without limitation, audio data, read only memory data, photo data, image data, video data, and software data. It is to be understood, that the use of the term player includes all devices that are capable of reading optical discs, such as, for example, audio optical disc players, computer optical disc-ROM drives, and DVD players.

Note that the present invention may be applied to optical discs 10 of varying shapes, including rectangular shaped optical discs having a width, to circular optical discs having a diameter of 120 mm, and to miniature optical discs having a width of less than 120 mm or a diameter of less than 120 mm. The increased capacity optical discs are particularly useful when a miniature optical disc is desired and a large storage capacity is desired. For example, optical discs having a diameter of 80 mm or optical discs shaped as business cards are often used in marketing or promotional schemes that require the optical disc to store more data than is traditionally possible when manufactured to conform to suggested Red Book specifications for 120 mm diameter optical discs.

Having thus described a preferred embodiment of an optical disc with increased storage capacity, it should be apparent to those skilled in the art that certain advantages of the within apparatus have been achieved. It should also be appreciated that various modifications, adaptations, and alternative embodiments thereof may be made within the scope and spirit of the present invention. For example, an optical disc having an 80 mm diameter with increased storage capacity has been illustrated, but it should be apparent that the inventive concepts described above would be equally applicable to optical discs having diameters and widths other than 80 mm. The invention is further defined by the following claims.

What is claimed is:

1. A method for manufacturing optical discs comprising a desired storage capacity, the optical discs comprising a plurality of spiral tracks formed on a substrate, each track comprising a plurality of pits and lands, the method comprising:
spacing adjacent tracks a predetermined distance from one another, the predetermined distance being based in part on the desired storage capacity of the optical disc; and,
selecting a width of the pits based in part on the predetermined distance between adjacent tracks so that the optical disc provides sufficient cross-talk levels for readability when the optical disc is scanned in players emitting a light that forms a spot comprising a diameter of about 1.7 microns or less when the spot contacts the tracks of the optical disc.

2. The method of claim 1, further comprising the step of measuring cross-talk levels of the optical disc, and reselecting the pit widths based in part on the measured cross-talk levels.

3. The method of claim 1, wherein the spacing adjacent tracks step further comprises spacing the adjacent tracks a predetermined distance of less than about 1.5 microns from one another.

4. The method of claim 1, wherein the spacing adjacent tracks step further comprises decreasing the predetermined distance between adjacent tracks when the desired storage capacity of the optical disc is increased.

5. The method of claim 1, wherein the selecting a pit width step further comprises decreasing the pit width when the predetermined distance between the tracks is decreased.

6. The method of claim 1, further comprising the steps of:
forming pits comprising predetermined pit lengths, the predetermined pit lengths being based in part on the desired storage capacity; and,
selecting a pit depth based in part on the predetermined pit lengths.

7. The method of claim 6, further comprising the step of measuring a data signal and a tracking signal of the optical disc, and reselecting the pit depth based in part on the measured data signal and the measured tracking signal.

8. The method of claim 7, further comprising the step of selecting a cross sectional pit shape based in part on the measured tracking signal.

9. The method of claim 8, wherein the step of selecting the cross sectional pit shape further comprises shaping the cross sectional pit shape to a substantially semi-hexagonal shape.

10. The method of claim 6, wherein the step of forming pits further comprises forming pits comprising shorter predetermined pit lengths when the desired storage capacity of the optical disc is increased.

11. An optical disc manufactured in accordance with the process of claim 1.

12. A method for manufacturing optical discs comprising a desired storage capacity, the optical discs comprising a plurality of spiral tracks formed on a substrate, each track comprising a plurality of pits and lands, and each pit configured to hold data units, the method comprising:
forming pits comprising predetermined pit lengths, the predetermined pit lengths being based in part on the desired storage capacity; and,
selecting pit depths of the pits based in part on the predetermined pit lengths so that the disc provides sufficient data signals and tracking signals for readability when the optical disc is scanned in players emitting a light that forms a spot comprising a diameter of about 1.7 microns or less when the spot contacts the tracks.

13. The method of claim 12, further comprising the step of measuring a data signal and a tracking signal of the optical disc, and reselecting the pit depth based in part on the measured data signal and the measured tracking signal.

14. The method of claim 13, further comprising the step of selecting a cross sectional pit shape based in part on the measured tracking signal.

15. The method of claim 12, wherein the forming pits step further comprises forming pits comprising a pit length per data unit of less than about 0.28 microns.

16. The method of claim 12, wherein the step of forming pits further comprises forming a plurality of pits comprising one of nine possible discrete pit lengths.

17. The method of claim 12, wherein the forming pits step further comprises decreasing the predetermined pit lengths when the desired storage capacity of the optical disc is increased.

18. The method of claim 12 wherein the selecting pit depths step further comprises selecting the pit depths closer to a depth of about one-quarter of a wavelength of the light emitted by the player when the light is in the substrate, when the predetermined pit lengths are decreased.

19. The method of claim 12 wherein the selecting pit depths step further comprises selecting the pit depths closer to about 125 nm when the predetermined pit lengths are decreased.

20. An optical disc manufactured in accordance with the process of claim 12.

21. An optical disc comprising a desired storage capacity, comprising:
a substrate comprising a plurality of spiral tracks formed thereon, each track comprising a series of pits and lands, wherein a predetermined distance between each adjacent track is less than about 1.5 microns, the pits comprising a pit width; and,
a reflective layer in contact with the tracks of the substrate, wherein the predetermined distance between each adjacent track is based in part on the desired storage capacity, and each pit width is based in part on the predetermined distance between adjacent tracks so that the disc provides sufficient cross-talk levels for readability when the optical disc is scanned in players emitting a light that forms a spot comprising a diameter of about 1.7 microns or less when the spot contacts the tracks of the substrate.

22. The optical disc of claim 21, wherein the optical disc comprises a width of less than about 120 mm and is configured to store more than about 200 Mbytes of data.

23. The optical disc of claim 21, wherein the optical disc is circular, and comprises a diameter of about 80 mm.

24. The optical disc of claim 21, wherein the pits widths are smaller when the predetermined distance between adjacent tracks is smaller.

25. The optical disc of claim 21, wherein the predetermined distance between adjacent tracks is smaller when the desired storage capacity is increased.

26. The optical disc of claim 21, wherein each pit comprises a predetermined pit length and a pit depth, wherein the predetermined pit lengths are based in part on the desired storage capacity, the pit depths being based in part on the predetermined pit lengths.

27. An optical disc comprising a desired storage capacity, comprising:
a substrate comprising a plurality of spiral tracks formed thereon, each track comprising a series of pits and lands, the pits being configured to hold data units, wherein each pit comprises a pit depth and a predetermined pit length, and each pit comprises a pit length per data unit of less than about 0.28 microns; and,
a reflective layer in contact with the tracks of the substrate, wherein the predetermined pit lengths are based in part on the desired storage capacity, the pit depths being based in part on the predetermined pit lengths so that the disc provides sufficient data signals and tracking signals for readability when the optical disc is scanned in players emitting a light that forms a spot comprising a diameter of about 1.7 microns or less when the spot contacts the tracks of the substrate.

28. The optical disc of claim 27, wherein the pit depth is closer to a depth of about one-quarter of a wavelength of the light emitted by the player when the light is in the substrate, when the predetermined pit lengths are shorter.

29. The optical disc of claim 28, wherein the pit depth is closer to a depth of about 125 nm when the predetermined pit lengths are shorter.

30. The optical disc of claim 27, wherein the pits comprise a substantially semi-hexagonal cross sectional shape.

31. The optical disc of claim 27, wherein the predetermined pit lengths are shorter when the desired storage capacity is increased.
